(19) United States
(12) Patent Application Publication
(10) Pub. No.: US 2026/0242075 A1
(43) Pub. Date: Aug. 20, 2026

(54) System for Controlling Pests on Plants

(71) Applicant: Chemspeed Research AG, Liestal (CH)

(72) Inventor: Rolf Gueller, Herznach (CH)

(21) Appl. No.: 18/881,777

(22) PCT Filed: Jul. 6, 2023
(86) PCT No.: PCT/CH2023/050024

§ 371 Date: Jan. 7, 2025

(30) Foreign Application Priority Data
Jul. 8, 2022 (CH) CH000815/2022

(51) Int. Cl. B64U 20/80; A01M 99/00; B64U 50/37; B64U 70/92; B64U 80/25; B64U 80/40; B64U 101/40; G05D 1/689; G05D 107/20; G05D 109/25

(52) U.S. Cl. CPC B64U 20/80; A01M 99/00; B64U 50/37; B64U 70/92; B64U 80/25; B64U 80/40; G05D 1/689; B64U 2101/40; B64U 2201/10; G05D 2107/21; G05D 2109/254

(57) ABSTRACT

A system for controlling pests on plants that are located in an agricultural area includes a swarm of drones which are configured to fly to plants autonomously, and a control device for controlling the drones. The control device and the drones are equipped with communication devices for mutual exchange of data. The drones are equipped with a sensor for detecting pest infestation on a plant and with a laser device suitable for pest control and configured to effect targeted control of detected pest infestation by means of the laser device.

### CROSS-REFERENCE TO RELATED APPLICATIONS

This application is the U.S. national phase of International Patent Application No. PCT/CH 2023/050024 filed Jul. 6, 2023, and claims priority to Swiss Patent Application No. CH 000815/2022 filed Jul. 8, 2022, the disclosures of which are hereby incorporated by reference in their entireties.

### BACKGROUND

### Field

The present invention relates to a pest control system in accordance with the preamble of independent patent claim 1.

In order to ensure the sustainable production of agricultural products it is imperative that useful plants be comprehensively protected against a variety of pests and this is becoming ever more important for all humanity as the need for agricultural products continues to grow. For reasons of environmental protection, the trend is away from chemical plant protection products and towards the use of physical methods of pest control.

### Description of Related Art

An article “Six Ways Drones Are Revolutionizing Agriculture” by Michal Mazur, which appeared in MIT Technology Review on 20 Jul. 2016, describes the possibility of using drones for agricultural work. The article mentions that drones equipped with suitable sensors and apparatus could be used, for example, for soil/field monitoring, planting, yield assessment, irrigation, plant health assessment, etc. It also mentions pest control in crops, where drones are being used for targeted spraying of plants with chemicals. Drones can also be configured for different tasks and it would also be possible to use a swarm of drones.

An article “Eyes in the sky: 5 ways drones will change agriculture” by Rachel Ehrenberg, which appeared on Knowablemagazin.org on 10 Nov. 2018, describes the possible future use of drones for agricultural work. The article mentions that drones equipped with suitable sensors could be used, for example, for detecting the ripeness of grapes in vineyards, for detecting undesirable plants in areas under cultivation, for detecting the need for irrigation, for detecting unhealthy plants or free-floating pathogens, and also, for example, for counting cattle or for artificially pollinating flowers. Specific forms of systems equipped with drones are not described.

EP 3 500 877 B1 describes a system for harvesting fruit, wherein a drone equipped with a camera detects and picks ripe fruit within a working area. The use of a plurality of drones is also mentioned.

An article “Licht statt Chemie” [“Light not chemicals”], which appeared on the News Portal phi of Produktionstechnik Hannover, describes a basic concept for a system of weed control in fields of crop plants, which system uses laser radiation rather than chemical treatment to partly destroy weeds at least to the extent that they can no longer damage the development of the crop plants. The article mentions that electronic image-recognition methods could be used to distinguish between crop plants and weeds. As an outlook it also mentions that lasers can also be used, for example, for pest control in plant breeding.

US 2019/0031346 A1 discloses a system for controlling pests on plants that are located in an agricultural area by means of drones, in which system the pest control is effected by spraying with pesticides.

### SUMMARY

The problem underlying the present invention is to improve a pest control system of the generic kind so that it is capable of controlling pests without human interaction and without the use of pesticides. The system should be suitable for use in any agricultural areas, especially including in mixed crops.

That problem is solved by the pest control system according to the invention as described herein. Advantageous embodiments will be found as described herein.

In the context of the present invention, pest control includes the control of harmful organisms on plants and of diseases caused by those organisms, as well as the control of pests that cause feeding damage. Accordingly, pests are to be understood as being harmful organisms or pests that cause feeding damage.

The core of the invention lies in the following: a system for controlling pests on plants that are located in an agricultural area comprises a swarm of drones and a control device for controlling the drones. The control device and the drones are equipped with communication devices for mutual exchange of data. The drones are configured to fly to plants autonomously and are each equipped with a sensor for detecting pest infestation and with a laser device suitable for pest control and are configured to effect targeted control of detected pest infestation by means of the laser device.

By means of the swarm of autonomously operating drones, which are preferably extremely small, a defined working area can be scanned for pests fully automatically and any infestation can be detected and autonomously controlled using suitable physical or mechanical means. The swarm of drones advantageously comprises a large number (ranging from dozens to hundreds or thousands) of small, lightweight and inexpensive drones operating in coordination with one another, the drones acting similarly to a swarm of bees or ants in order to perform their work in a manner that is targeted selectively on target plants, this being in contrast to traditional agriculture where treatments are applied over a large area and are non-diversified and non-targeted. Preferably the drones have only small dimensions in the range below 25 cm, preferably in the range of 2-25 cm or in the range of 0.5-15 cm. Preferably the drones have a low maximum take-off weight of less than 500 g, preferably in the range of 5-500 g. As a result, firstly the drones are inexpensive, which also allows them to be used in large numbers, and secondly they are also safer than heavier aircraft, because they present less risk to both humans and environment in the event of a crash.

A particular advantage of the system according to the invention in connection with pest control is that, in contrast to traditional chemical methods of pest control which are usually employed over a large area and act equally on infested plants and uninfested plants alike, the drones are able to operate very selectively, so that only actually infested plants or parts of the plants are treated. The system according to the invention is also especially suitable for finding and controlling potential pest infestation in individual plants at an early stage, before an infestation is able to spread to further plants or even to whole areas, and accordingly contributes to low-impact, low-risk and efficient agriculture as a whole.

By using a laser device as control tool it is possible for very targeted pest control to be carried out.

Advantageously the laser device has an automatically adjustable optical system by means of which the focal point is adjustable. As a result, the drone does not have to fly to a precise distance from the target object, because the adjustable optical system allows an optimum focal point in the target object.

Preferably the control device is configured to define an agricultural target area to be treated and to communicate that target area to the drones, and the drones are configured to fly to plants within the defined target area, thereby allowing efficient and targeted treatment.

The control device is advantageously configured to control the drones so that the defined target area is first scanned for pest infestation, and only once that search is complete is the required treatment determined by the control device and corresponding assignments transmitted to selected drones for executing desired treatment steps.

A particular advantage of the system according to the invention is the possibility of inspecting and, if necessary, treating individual plants. This makes it possible to plant more mixed crops, for example instead of homogenous monocultures which have a large number of disadvantages from an ecological standpoint (they have little ecological value, because diversity of useful organisms is barely supported, and are especially highly susceptible to pests specialising in individual useful plants or a small number of useful plants). Mixed crops are distinguished by the planting and cultivation of different useful plants alongside one another and intercropped. The individual useful plants profit from mutual advantages such as improved nutrient availability or a more resilient ecosystem resulting from diverse communities. The disadvantage of such mixed crops, namely the difficulty, if not the impossibility, of traditional management by selective pest control, does not arise in the case of the system according to the invention, because the drones are able to seek out the individual desired plants in the entire area of the mixed crop and treat those plants as required. A correspondingly equipped swarm of drones can search a region having a plurality of intercropped useful plant varieties and, if required, carry out pest control.

Preferably the drones are configured to communicate with one another directly or via the control device. It is thus possible, for example, to avoid collisions between the drones.

Advantageously the drones are configured to transmit data captured by their sensors to the control device, and the control device is configured to analyse data transmitted by the drones and consequently transmit control information to the drones. In this way a large part of the control work is outsourced to the control device, so that the mobile drones can be of simpler and correspondingly more lightweight construction.

The sensor or at least one of the sensors of each drone is advantageously configured as a camera. The camera can operate in the visible range or in the infrared or UV range. Instead of a camera or in addition thereto, the drones can also be equipped with ultrasonic sensors, radar sensors or laser sensors. Such sensors make it possible, for example, to detect pest infestation or facilitate the navigation of the drones.

Advantageously the drones are equipped for navigation with a position determination device. This allows more targeted use of each drone and a more exact positional overview.

By means of the laser device of each drone, it is possible for an organism on the target object to be weakened, sterilised, killed or destroyed.

Advantageously the drones have an orientation arrangement for orienting the laser device with respect to a target object. As a result, more precise treatment of the target object is possible irrespective of the exact position of the drones.

Preferably the drones are electrically operated and equipped with an electrical energy storage means (rechargeable battery). The system advantageously comprises at least one charging device for the energy storage means of the drones. In the event of their energy storage means requiring charging, the drones are advantageously configured to discontinue their activity, autonomously fly to the at least one charging device and charge their energy storage means. In this way the operating time of the drones is virtually unlimited. Advantageously the drones are configured to resume their activity automatically once their energy storage means has been charged.

Advantageously the system has at least one landing platform for the drones, the landing platform offering space for a plurality of drones and the at least one charging device being integrated in the landing platform. The drones thus have a safe place to land, particularly for charging.

In an advantageous embodiment, the landing platform has an electrical charging energy storage means for supplying energy to the at least one charging device and has a photovoltaic panel or is itself configured as a photovoltaic panel, the charging energy storage means being chargeable by means of the photovoltaic panel. In favourable conditions, this allows energy self-sufficient operation over a prolonged period.

Advantageously the landing platform is mobile, especially self-propelling. This facilitates installation in a field.

The control device (with the exception of the communication device) can be designed entirely as a virtual unit (all data processing, evaluation and issuing of commands/control via suitable programs in the internet/in the cloud), or can comprise a physical central control unit or physical decentralised control units (possibly even as part of the drones themselves) which itself/themselves has/have corresponding processing units.

In that case a physical central or decentralised control unit for controlling the drones advantageously has a processing unit, a communication device and an energy supply.

Preferably a physical central or decentralised control unit is also configured as a storage and landing platform having integrated charging devices for the drones.

Advantageously the communication devices of the system are configured for mutual communication or data exchange with the individual parts of the device via a telephone network, radio, Bluetooth, wireless, IR or lasers.

The central control unit is advantageously configured as a communication hub for communication with and between the drones and if applicable a remote monitoring unit.

Advantageously the drones are equipped with solar cells for charging their energy storage means. It is thereby possible to dispense with separate charging stations.

The physical central control device is advantageously mobile, so that it can be transported to a deployment area. In that case the central control device is advantageously configured to move autonomously to the deployment area and within that deployment area. The physical central control device can also itself be capable of flying.

### BRIEF DESCRIPTION OF THE DRAWINGS

The terms Fig., Figs., Figure, and Figures are used interchangeably in the specification to refer to the corresponding figures in the drawings.

The pest control system according to the invention will now be described in greater detail on the basis of various exemplary embodiments and referring to the accompanying drawings, wherein:

FIG. 1—is a block diagram of a first exemplary embodiment of the system according to the invention;

FIG. 2—is a block diagram of a second exemplary embodiment of the system according to the invention;

FIGS. 3-4—show simplified views of a control device of the system according to the invention with drones in the idle state and the in-use state;

FIG. 5—shows a simplified diagrammatic view of a mobile control device;

FIG. 6—shows a diagrammatic view of a fixed-position control device;

FIG. 7—shows an exemplary arrangement of fixed-position control devices in an agricultural field;

FIG. 8—shows a simplified view of a drone of the system according to the invention;

FIGS. 9-12—show simplified views of different control tools of the drones;

FIGS. 13-14—show views illustrating the mode of operation of a control tool of the drones; and

FIGS. 15-18—show views of an exemplary embodiment of the system according to the invention in various phases of field use, using the example of a mixed crop field.

### DESCRIPTION

The following observations apply in respect of the description which follows: where, for the purpose of clarity of the drawings, reference signs are included in a Figure but are not mentioned in the directly associated part of the description, reference should be made to the explanation of those reference signs in the preceding or subsequent parts of the description. Conversely, to avoid overcomplication of the drawings, reference signs that are less relevant for immediate understanding are not included in all Figures. In that case, reference should be made to the other Figures.

The term “drone” is understood as meaning an unmanned aircraft which can be operated and navigated autonomously, without an onboard crew, by an internal computer and/or externally via a remote control system.

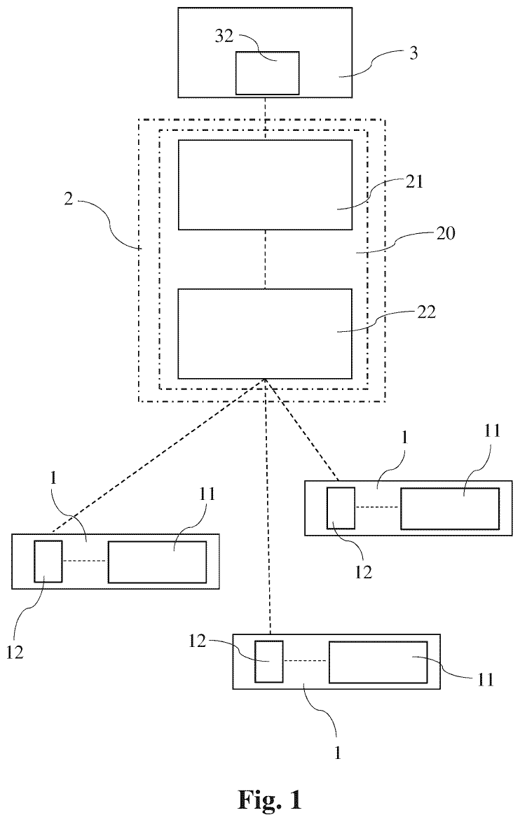

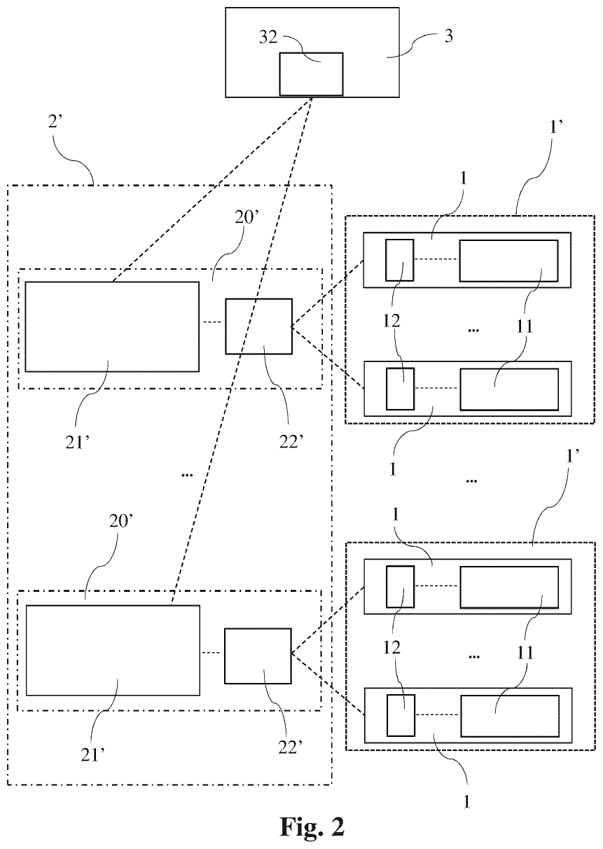

Basically the system according to the invention comprises as most important components a plurality of drones 1 and a control device 2, 2′ for the drones 1 as well as a local computer 3. For reasons of clarity, the drones in the Figures of the drawings are all indicated as a whole by the same reference numeral 1 irrespective of the specific details of their construction. FIGS. 1 and 2 show only a small number of drones 1, but in reality the system according to the invention comprises a substantially larger number of drones 1. The local computer 3 is normally located at the operational base of the system (for example at an agricultural facility) and serves as a user interface for the exchange of data and instructions with the control device 2, 2′. The user operates the system via the local computer 3. He plans deployments, defines deployment areas, working methods, timetables etc., and initiates and monitors deployment. In addition, this is also where the evaluation of completed deployments, monitoring of the state of the drones located in the field etc. is carried out

In the exemplary embodiment of FIG. 1, the control device 2 comprises a central control unit 20, which in turn comprises a processing unit 21 and a communication device 22. The drones 1 each comprise an internal controller 11 and an internal communication device 12. The control device 2 and the drones 1 communicate with one another via the communication device 22 and the internal communication devices 12, so that data can be mutually transmitted and exchanged between the central control unit 20 or its processing unit 21 and the internal controllers 11. The local computer 3 likewise has a communication device 32 for exchange of data with the central control unit 20.

In the exemplary embodiment of FIG. 2, the control device 2′ has a decentralised layout and comprises two or more decentralised control units 20′ (all having the same reference numerals in FIG. 2) which in turn each comprise a processing unit 21′ and a communication device 22′. The drones 1 are organised in groups 1′ and again each comprise an internal controller 11 and an internal communication device 12. Each group 1′ of drones 1 is assigned to one of the decentralised control units 20′. The number of drones 1 within the groups 1′ can be the same or different. The decentralised control units 20′ and the drones 1 communicate with one another via the communication devices 22′ and the internal communication devices 12 of the drones 1, so that data can be mutually transmitted and exchanged between the decentralised control units 20′ and the drones 1. The local computer 3 likewise communicates with the decentralised control units 20′ via its communication device 32. The communication between the decentralised control units 20′ and the mobile drones 1 as well as with the local computer 3 can, of course, also be effected indirectly via a central communication device not described herein.

The decentralised control units 20′, each together with a respective dedicated energy supply, are configured as independent physical units which are placed in the field to be treated when the system is in operation. Each unit preferably has at least one landing platform and charging station for the drones 1.

The communication between the drones 1 and the control device 2, 2′ is preferably effected wirelessly via suitable technology, such as, for example, radio, a mobile telephone network, lasers, Bluetooth, Wi-Fi.

The basic concept of the invention lies in the performance of desired agricultural work by means of a multiplicity of largely autonomously operating drones. Accordingly, the drones 1 are provided with special tools, especially control tools, with the aid of which one or more types of agricultural work can be performed. Such work includes primarily the control of pests on plants, but also, for example, the harvesting of fruit, removal of weeds, pollination of flowers, fertilisation, irrigation, planting of seeds or seedlings etc. The drones 1, together with the control device 2, 2′, form an autonomous system, linked by a communication network, for performing desired agricultural work. The “intelligence” of the system, that is to say the functionalities necessary for the flying and navigation of the drones as well as for the control of the control tools and the processing of data captured by the drones and for the consequent derivation of instructions for the drones, is shared between the internal controllers 11 of the drones 1 and the central control unit 20 or the decentralised control units 20′, the majority of the processing power required for that purpose preferably being provided by the central control unit 20 or the decentralised control units 20′, so that the internal controller 11 of the drones 1 can be relatively less complex.

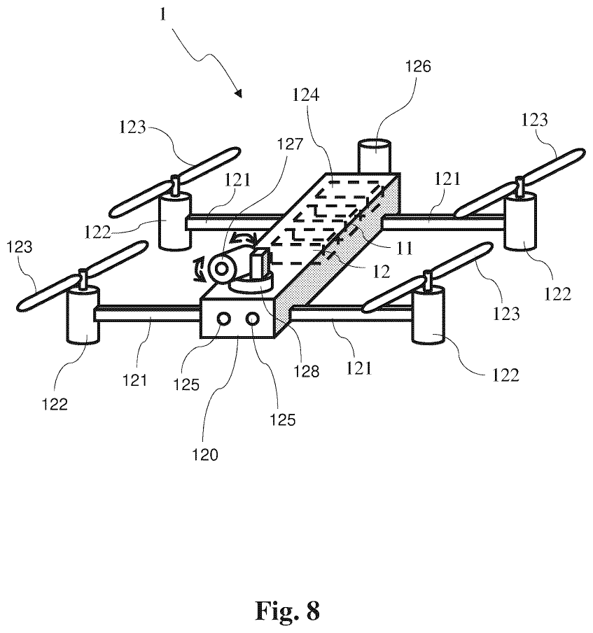

In accordance with an important aspect of the invention, the drones 1 are electrically operated. A typical example of a drone is shown in FIG. 8. The drone is here configured by way of example as a quadrocopter. Quadrocopter drones having four individually controllable rotors require only relatively simple control electronics and do not need any kind of additional movable control elements, because all directional movements of the drone's flight are effected exclusively by co-ordinated alteration of the speeds of the individual rotors. This accordingly enables a large number of small drones to be manufactured very economically.

It will be understood that other types of drone (ornithopters having flapping wings, helicopters equipped with main and tail rotors, helicopters with counter-rotating rotors, or fixed-wing aircraft, or motor-driven airship-like drones, etc.) can be used as drones.

The drone indicated as a whole by reference numeral 1 in FIG. 8 comprises a fuselage 120, on which four electric motors 122 are mounted via booms 121, which motors drive horizontally located, vertically acting rotors 123. The fuselage 120 houses the internal controller 11, the internal communication device 12 and an energy storage means in the form of a rechargeable battery 124.

The drone 1 has sensors 125 which enable it to sense the environment. For example, a sensor is configured as a camera operating in the visible range. Advantageously, however, it may also have sensors which operate in the infrared range, the UV range or in other wavelength ranges, so that it is possible, for example, to detect any damaged or pest-infested plants or parts of plants on the basis of their thermal radiation or UV radiation, which is different from that of healthy or uninfested plants, and to detect and even identify the infestation. The detection of (useful) plants, pests, fruits, etc. is effected by means of correspondingly suitable image-recognition systems. Such systems are advantageously implemented in the central control unit 20 or the decentralised control units 20′, which is or are equipped with processing power appropriate for that purpose. As a result, the internal control unit 11 of the drone 1 need not itself contain any complex image-recognition and analysis system and can therefore be kept small and lightweight.

In order that the position of the drone 1 can be determined at all times, it is equipped with a position determination device 126. Such a position determination device can be, for example, a GPS receiver, but may also be, for example, a gyroscope-assisted system or a system utilising acceleration measurement.

The drone 1 further comprises a control tool, which in the example shown here is in the form of a laser device 127 with which pests can be irradiated and accordingly sterilised, damaged or even destroyed, depending upon the laser power and irradiation time. Other control tools are listed and explained hereinbelow. Advantageously the control tool or the laser device 127 is mounted on an orientation arrangement 128 which is orientable in one or more axes and which allows the control tool 127 to be oriented with respect to a desired target object independently of the orientation and position of the drone 1 itself. Such an orientation arrangement can be dispensed with, however, if the flight controller of the drone itself is also capable of sufficiently precisely and exactly positioning a fixedly mounted tool accurately in three-dimensional space by orienting the entire drone with respect to a target object and maintaining that position long enough for the control tool to perform and finish its task.

The laser device 127 used as control tool for the pest control is designed so that its focal point is about 1-200 cm away from the laser device. Advantageously the laser device 127 has an automatically adjustable optical system (focussing lens) by means of which the focal point can be adjusted as required within a certain range. This means that the drone does not need to fly to a precise distance from the target object, because the adjustable optical system allows an optimum focal point in the target object. A suitable adjustment mechanism corresponds to the technical standard and is not further described herein.

For controlling harmful organisms, lasers having a wavelength of from 10-5 to 106 nm are suitable. For controlling weeds it is possible to use, for example, a CO₂ laser having a wavelength of 10,600 nm or a thulium fibre laser having a wavelength of about 2000 nm.

Depending upon the area of application of the drone 1 it can be advantageous for further aids, for example cameras or laser distance-measuring devices, to be added to the orientation arrangement 128 in addition to the control tool, such further aids allowing better identification of a target object than would be possible with the sensors 125 of the drone itself or allowing determination of the exact distance from the target object, which in turn would allow optimum adjustment of, for example, the focal point of the laser device 127 for pest control. Such optional sensors and tools (not shown) can advantageously likewise be mounted on the orientation arrangement. It will be understood that it is also possible and advantageous to equip a drone with a variety of tools suitable for different tasks. For example, such a multi-purpose drone could be equipped with a laser device for pest control and at the same time with a gripper, for example as a harvesting and weeding tool.

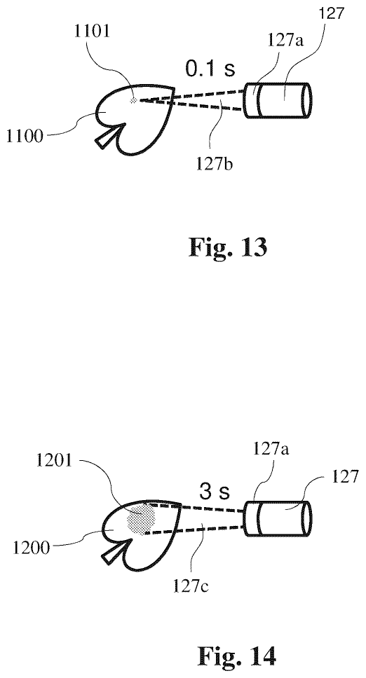

Tests have shown that even using a small laser of 2 W power and a wavelength of 405 nm, organic material can be caused to ignite after a period ranging from only a few milliseconds to a few seconds, even at distances of 1-2 metres. In order to control a harmful organism, however, even lower power per unit time is sufficient, because a target organism need not necessarily be burnt, but simply needs to be damaged to an extent such that it dies or can no longer reproduce. This is shown in simplified diagrammatic form in FIG. 13. Using a laser beam 127b focussed onto a small point by means of a focussing lens 127a it is possible to damage small areas of harmful organisms 1101 on a plant 1100 even with short laser pulses of, for example, 0.1 s duration. In contrast thereto, FIG. 14 shows a larger area of pest infestation 1201 on a plant 1200, which is irradiated by the same laser device 127 with a laser beam 127c widely/diffusely focussed by the focussing lens 127a. In this case a considerably longer irradiation time of, for example, 3 s is necessary in order to apply sufficient laser energy to the entire surface of the harmful organism 1201 and to damage that organism.

Advantageously the work tool (especially the laser device 127) is mounted on the drone 1 so that as large as possible a region both vertically and horizontally can be acted upon by the tool, without the drone itself needing to be oriented by corresponding flight manoeuvres.

Depending upon the area of application, other control tools are also possible. For harvesting fruits, for example berries and nuts, but also larger fruit and vegetables depending upon the size of the drones, a suitably constructed gripping tool is advantageous as control tool, if necessary replaced by or supplemented by tongs or scissors or an additional laser device which is able to cut through parts of plants, such as, for example, the stem of a fruit or leaf.

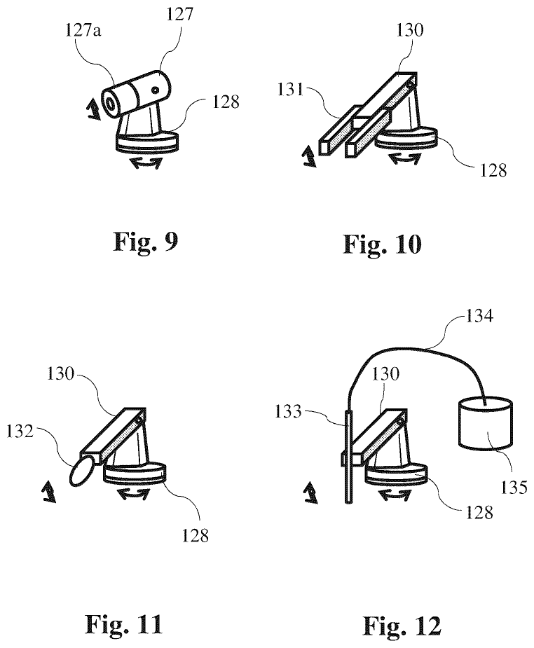

FIGS. 9 to 12 show, in very simplified form, various control tools of the drones 1 for a variety of agricultural tasks.

FIG. 9, as in FIG. 8, shows a laser device 127, designed for pest control, which is mounted on an orientation arrangement 128 by means of which it is orientable with respect to a target object. A focussing device 127a, for example in the form of an adjustable lens system, allows the laser beam to be focussed, as required, onto a defined point or onto a defined area (in this connection see also the comments relating to FIGS. 13 and 14).

FIG. 10 shows a mechanical control tool in the form of a gripper 131 mounted on a mini-robot arm 130 which is in turn mounted on an orientation arrangement 128. The gripper 131 is configured so that, for example, it is able to grip, remove and transport parts of plants, fruits, etc.

FIG. 11 shows a control tool, designed especially for the pollination of flowers, in the form of a pollination brush 132 mounted on a mini-robot arm 130. Using the pollination brush 132, pollen can be transported from one flower to one or more other flower(s), where the pollen is deposited. In this case too, the mini-robot arm 130 is mounted on an orientation arrangement 128.

FIG. 12 shows a control tool in the form of a metering device 133 for selectively dispensing fluids (for example water, fertiliser, a special biocide, a plant protection product). The metering device 133 is mounted on a robot arm 130, which is in turn mounted on an orientation arrangement 128, and connected to a fluid reservoir 135 via a fluid line 134. The metering device 133 can dispense fluid in precise volumes and with great accuracy at a desired target position. Of course, all common metering devices for fluids and solids (pipettes, pre-filled cartridges, metering containers, . . . ) can be used. And it is, of course, also possible, depending upon the area of application, to dispense with individual subsidiary devices. For example, it would be possible to do without the orientation arrangement 128 if the drone 1 is itself technically configured so that it can be positioned in such a way that a fixedly mounted control tool can be oriented and positioned with respect to a target object with sufficient accuracy and precision.

Depending upon the particular application, the exhaust air of the rotors of the drones can itself be used to perform tasks, for example impurities (dust, soot, organic material) can be blown away and thus removed using the wind from the rotors.

The drone 1 can also be equipped with photovoltaic cells (not shown in the drawings), for example in the form of a coating on the rotors, or photovoltaic cells on the fuselage, etc., which enable the energy storage means 124 to be charged during flight, but especially once the drone has landed. The amount of energy gained thereby can be utilised for an emergency landing or an emergency return flight of the drone.

As already explained, the individual drones 1 are differently constructed, depending upon their specific intended use. All of them have in common, however, that they have small dimensions and a low maximum take-off weight, which allows them to be manufactured inexpensively and accordingly deployed in large numbers. Moreover, lightweight drones are safer than heavier aircraft and present hardly any risk to humans and environment in the event of a crash. A size (largest dimension) of less than 25 cm, preferably 2-25 cm, and a maximum take-off weight of less than 500 g, preferably 5-500 g, are optimum, but slightly larger/heavier and, especially, smaller/lighter drones are also possible.

An important requirement placed on the drones is that (in flight) they can be positioned extremely accurately and precisely relative to a target object (for example a plant) and have a stable flight attitude.

Since the control tools mounted on the drone often need to be oriented very exactly (centimetre to millimetre range) with respect to a target object (for example a harmful organism on the plant, fruit to be harvested, etc. . . . ) and/or need to maintain a clearly defined position as exactly as possible for several seconds in order that, for example, a control tool, such as a laser device or gripper, has sufficient time to perform its task, extremely precise positioning in three-dimensional space is required. The technologies necessary therefor are available to the person skilled in the art and therefore need no further explanation.

The system according to the invention need not have only a single type of drones, but can also comprise differently constructed drones, those drones and their control tools being designed and optimised for different tasks. For example, some drones can be configured for pest control, while other drones, which may optionally be used at the same time, are configured for the cultivation of agricultural plants (irrigation, planting/sowing, pollination) and others again are equipped for harvesting or weeding.

The central control unit 20 of the control device 2 can be purely virtual, for example in the form of a corresponding program and databank structure in the internet or a cloud. However, it can also be configured as a physical unit. The same applies to the decentralised control units 20′ of the control device 2′.

The control device 2, 2′ is configured so that it is able to communicate both with idle (landed) drones 1 and with drones 1 currently in use (flying), for example in order to obtain position details and images or other sensor data from the drones 1 currently in use. Such data are evaluated by the control device 2, 2′ and on that basis the control device 2, 2′ transmits detailed instructions to the drones 1 or even controls the drones itself. Since the main processing work is accordingly carried out directly in the control device 2, 2′, the drones 1 can be kept sufficiently small and lightweight, which is advantageous insofar as the drones can be both less expensive and simpler in construction and have a favourable weight ratio between the actual drone, the rechargeable battery necessary for operation and the payload of the drone represented by the control tool.

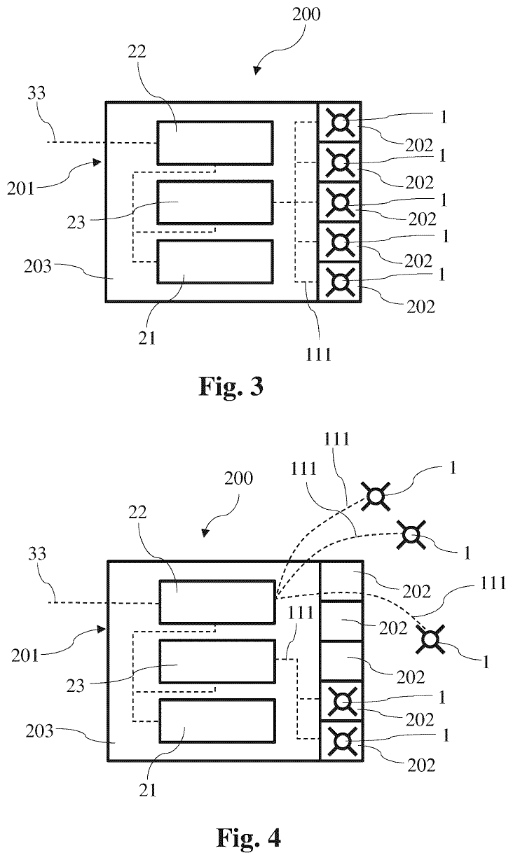

FIGS. 3 and 4 show, in diagrammatic form, a practical implementation of the control device 2. The control device, indicated as a whole by reference numeral 200, comprises a housing 201, in which the processing unit 21 and the communication device 22 as well as a charging energy storage means 23 are housed. An upper side of the housing 201 is configured as a landing platform 203. In or on the landing platform 203 there are arranged a plurality of (in the example shown: five) charging devices 202 which are fed by the charging energy storage means 23. The charging devices 202 can be configured, for example, as inductive charging devices which allow contactless charging. The drones 1 are able to fly to the landing platform or its charging devices 202 in order to (re)charge their energy storage means there. FIG. 3 shows the control device 200 in the storage/idle state, all the drones 1 being located on the landing platform 203. FIG. 4 shows the control device 200 in a state in which some of the drones 1 are in use and other drones are located on the charging devices of the landing platform. The dashed lines 111 and 33 symbolise the communication links between the communication device 22 and the drones 1 and the local computer 3 (not shown herein), respectively.

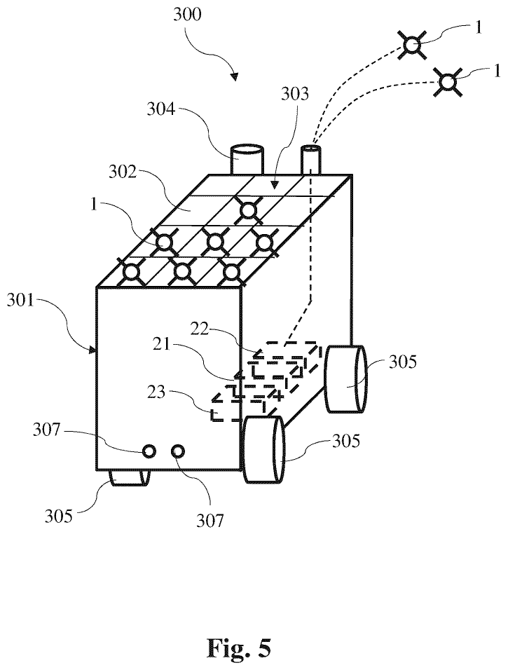

FIG. 5 shows a mobile implementation of the control device in the form of an autonomously mobile control apparatus. With the exception of a few additional components, the control device, here indicated as a whole by reference numeral 300, is constructed in the same way as the control device shown in FIGS. 3 and 4. The control device 300 comprises a housing 301, in which the processing unit 21 and the communication device 22 as well as the charging energy storage means 23 are housed. An upper side of the housing 301 is configured as a landing platform 303. In or on the landing platform 303 there are arranged a plurality of (in the example shown: twelve) charging devices 302 which are fed by the charging energy storage means 23. The charging devices 202 can be configured, for example, as inductive charging devices which allow contactless charging. The drones 1 are able to fly to the charging devices 302 in order to (re)charge their rechargeable batteries. The landing platform 303 is equipped with photovoltaic cells and serves as energy supplier for the charging energy storage means 23. In addition, the control device 300 comprises a position determination device 304, for example a GPS receiver, and a movement device which is here symbolised, for example, by wheels 305 which are preferably motor-driven. Alternatively, the movement device can also be configured as a caterpillar drive or in the form of walking legs. The movement device is controlled by the processing unit 21 assisted by the position determination device 304 and sensors 307, so that the control device 300 (guided by instructions from the local computer 3) is autonomously movable. The autonomously mobile control device 300 can, for example, autonomously search for its deployment area or return to base therefrom. It can also autonomously follow the swarm of drones working in the deployment area in order to supply it with radio information and instructions and provide optimum assistance as a charging station. In a further special configuration, the mobile control device could itself be not only capable of travel but also even capable of flying and act as it were as a travelling or flying “mother ship” for the swarm of drones.

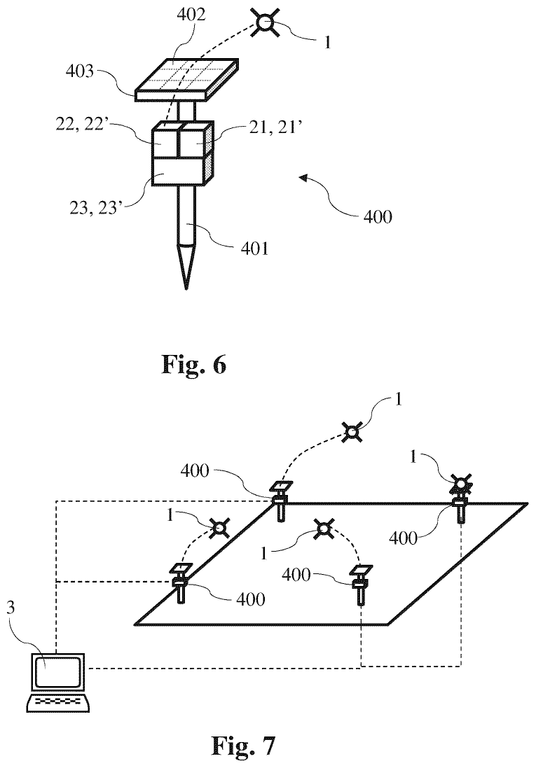

FIG. 6 shows an alternative implementation of a control device. The control device, here indicated as a whole by reference numeral 400, is suitable for use on its own (as central control unit 20) or in a multiple configuration (as decentralised control units 20′) and is configured as a physical unit to be set up in a fixed position, for example close to, directly at or in the agricultural areas to be treated. For that purpose it comprises a post (ground spike) 401 which in the erected state is advantageously tall enough to project above the vegetation. Mounted on the post 401 are, in the case of a central control unit, a processing unit 21, a communication device 22 and a charging energy storage means 23 and, in the case of decentralised control units, a processing unit 21′, a communication device 22′ and a charging energy storage means 23′. In addition, a landing platform 403 for one or more drones 1 is arranged at the end of the post 401. The landing platform 403 is equipped with photovoltaic cells and serves an energy supplier for the charging energy storage means 23, 23′. Furthermore, in or on the landing platform 403 there is arranged at least one charging device 402 for drones 1 landing on it. The charging devices 402 can be configured, for example, as inductive charging devices which allow contactless charging. In sufficient light conditions, the charging energy storage means 23, 23′ is charged via the photovoltaic surface of the landing platform 403 and that stored energy is used for operating the processing unit 21, 21′ and the communication device 22, 22′ as well as for charging the drones 1 and allows largely autonomous use of the entire control device.

FIG. 7 shows how a plurality of such decentralised control devices 400 can be arranged on a field to be treated by the system according to the invention. The Figure shows by way of example four control devices 400, each of which is assigned (here by way of example) one drone 1. The control devices 400 are in communication with the local computer 3. Of course, in practice, many more drones are in use and are assigned in groups to the individual decentralised control devices. The control-and data-related organisation of the device accordingly corresponds to that according to FIG. 2.

The treatment of an agricultural area by means of the system according to the invention typically comprises the following steps:

The user determines the desired deployment area (target area) using the local computer 3. That area can be, for example, a coherent agricultural area or a plurality of non-coherent sub-areas.

The user determines which task(s) (for example control of Pest A, control of pest B, harvesting of agricultural product C, harvesting of agricultural product D, irrigation at location X, sowing of plant E, pollination of plant F . . . ) is(are) to be carried out in the defined deployment area.

The user determines which system components (central control device, decentralised control devices, types of drones) are to carry out the work.

Depending upon the embodiment, the control device(s) is(are) either moved to the defined deployment area by the user or they move autonomously to that area. Alternatively, the control device(s) can also be mounted in fixed position in or around the deployment area (see FIG. 7).

The central or decentrally configured control device begins its work and sends the drones on their way in order to perform the task. The control device in each case sends the individual drones into a sub-area which the drones, by means of their sensors, then search in a grid pattern for a desired agricultural parameter (for example pest infestation). Advantageously the evaluation of the sensor data of the drones is not carried out in the drone itself (which, due to its extremely small design, does not have a suitably powerful processing unit for evaluating the sensor data), but rather the data are sent to the control device and evaluated therein.

The control device evaluates the data collected by the drones, identifies regions of the working area (groups of plants, plants, parts of plants) which correspond to the desired parameter and need to be treated or acted upon, and issues the instructions to carry out the task to selected drones.

The drones so instructed move to their allocated target and act upon that target. Depending upon the task, this can include, for example, the selective control of pests using an inbuilt laser device or some other suitable tool, the targeted harvesting of individual fruits, or the performance of other tasks by the drones.

If the battery charge of individual drones falls below a specified value (defined by the energy required for the task and by the flight distance to the target and back to a landing platform), the individual drones return to the central control device or to one of the decentralised control devices, where they land on the landing platform(s) and are recharged for further use.

Other, still sufficiently charged drones continue the work of the withdrawn drones at the point where the latter discontinued their work due to their low battery state.

Advantageously the control device is configured so that all available drones are co-ordinated in such a way that the defined deployment area can be acted upon in an optimum way and as efficiently as possible. For example, in a first “reconnaissance phase” a swarm consisting of a multiplicity of drones is despatched, each individual drone of the swarm surveying a defined sub-region of the working area. If, in so doing, a drone finds plants which need to be treated, it begins that work. If the amount of work is identified as being too much for one drone (for example plants infested with pests over a large area or a “mass infestation” of several plants, or the picking of fruit at an optimum state of ripeness), the control device summons further drones for assistance. In this case it is especially advantageous for the drones to be very small and therefore inexpensive, thus allowing a multiplicity (ranging from dozens to hundreds or even thousands, that is to say an entire swarm) of drones to be in use simultaneously, and any individual losses of such small inexpensive drones do not have a particularly negative effect.

In a special configuration of the system according to the invention, the (central) control device, with the exception of the navigation controller, does without a physical processing unit, and all the data processing, organisation and issuing of commands to the drones is effected exclusively via a virtual controller which exists as a program and databank structure in the internet or in the cloud. In that case the drones are configured so that they are able to charge their energy storage means autonomously (for example by seeking out a ground-based charging device or, advantageously, even by means of solar cells built into the drone) and are connected to the virtual controller solely via, for example, a radio or telephone network and thereby exchange data therewith or receive commands therefrom. In such a swarm, a drone would, for example, be assigned a task, perform that task autonomously (or under the control of the virtual controller), and if necessary (low battery charge) land, recharge and, once charging was complete, autonomously resume its work again or continue with a different task at a different location if, during charging, its previous task had already been performed and completed by other, correspondingly instructed drones.

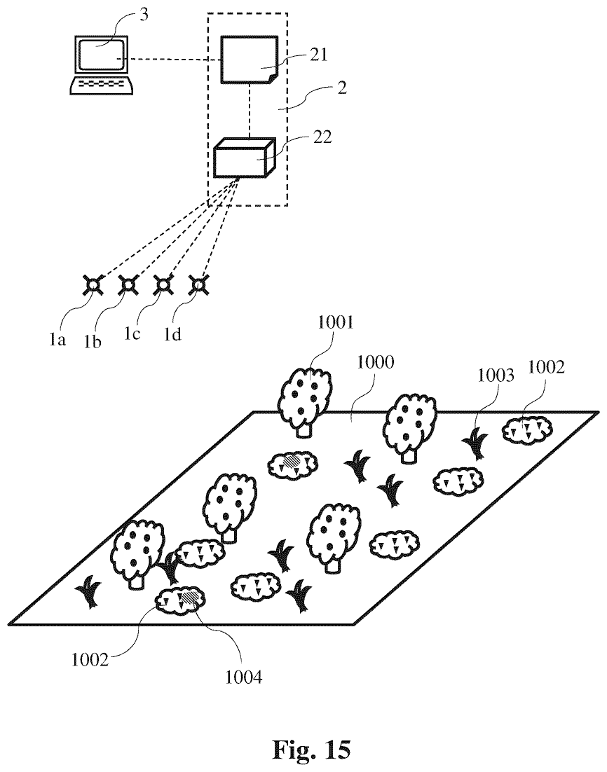

FIG. 15 shows an agricultural field 1000 to be treated, the field being cultivated as a mixed crop. Here different useful plants (for example fruit-bearing plants 1001 and 1002) and also weeds 1003 and plants (for example of same kind as 1002) exhibiting pest infestation 1004 are growing amongst one another in the field.

A plurality of drones in idle mode are being stored, i.e. parked on a landing platform, in the vicinity of the field 1000 and are connected via radio with a communication device 22, which in turn is connected to a virtual internet/cloud-based central control unit 21, the latter in turn being connected to a local computer 3 at the user's base, as explained in detail in connection with FIG. 1. For better understanding of the following comments, the four drones shown here are indicated by reference numerals 1a, 1b, 1c and 1d.

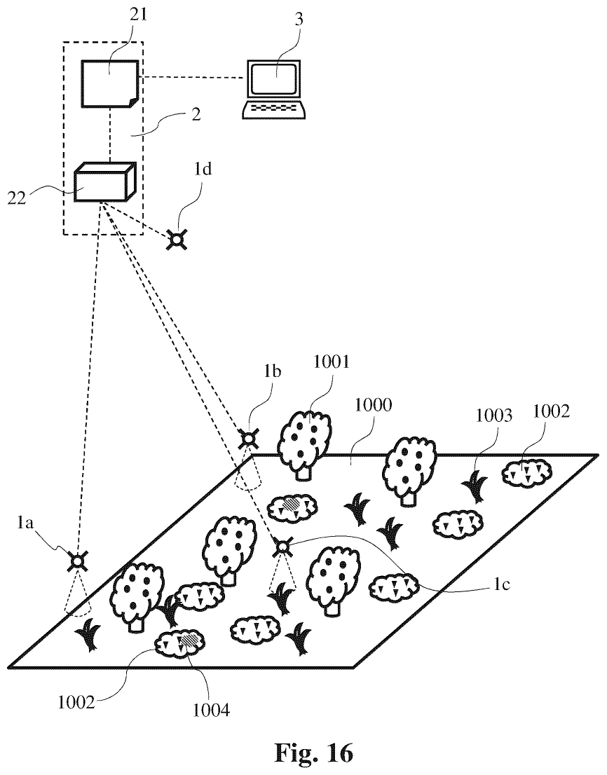

FIG. 16 shows the field 1000 after some of the drones, here 1a, 1b and 1c, initiated by the user using the local computer 3 and controlled by the virtual control unit 21 via the communication device 22, have begun their work and are scanning the entire field for desired parameters (presence of ripe fruit, presence of pests, . . . ) . A further drone 1d currently has too low a battery charge and remains in the idle state in order to undergo electrical charging by means of its inbuilt solar cells.

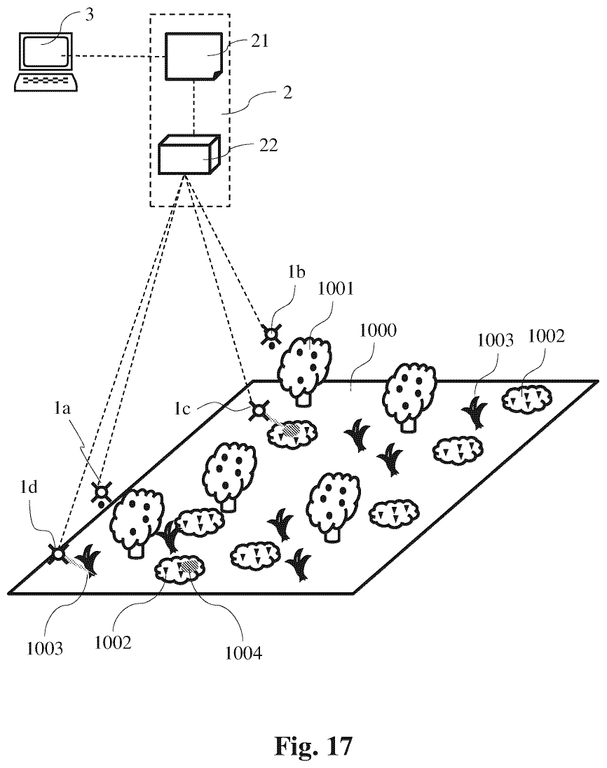

Once the current status of the field 1000, that is to say the various useful and harmful organisms 1001, 1002, 1003 and 1004, have been detected, the control unit 21 defines the current needs and, on that basis, assigns tasks to the individual drones or controls the drones so that they complete those tasks, as shown in FIG. 17. Drones 1a and 1b are collecting ripe fruits from plants of type 1001, while drone 1c is controlling pest infestation detected on plant type 1002 by means of a laser. Drone 1d, which was previously still charging, has now been charged and is ready for use; it has been tasked with controlling the weed type 1003 and is carrying out that task likewise by the use of a laser.

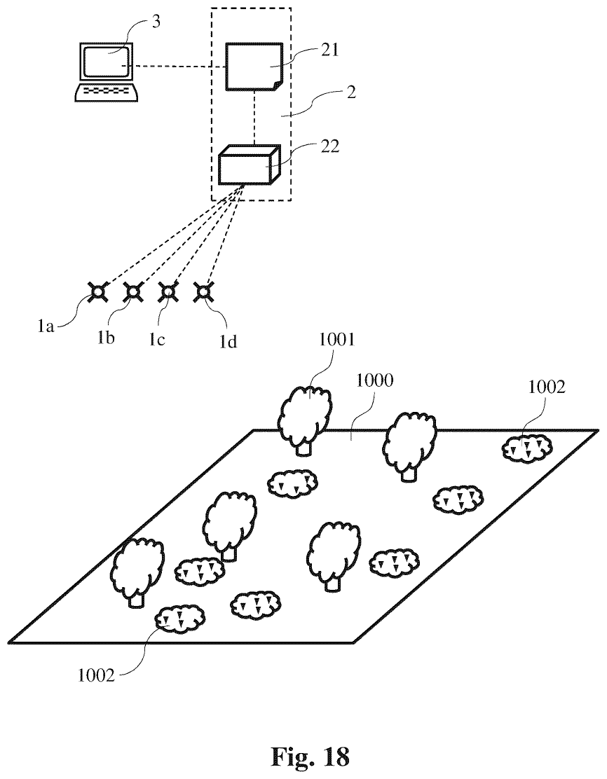

FIG. 18 then shows the state of the mixed crop field 1000 after treatment is complete. The pest infestation 1004 on the plants of type 1002 has been successfully controlled and the ripe fruits of type 1001 have been harvested. Drones 1a to 1d have landed away from the field (for example on a landing platform), are in an idle state and are being charged by means of their solar cells. In a further round of work, the scanning of the field would then be repeated and, for the purpose of as early as possible detection, the field would be monitored again for the reappearance or a fresh outbreak of pests, and fruits of type 1002 would be checked for their degree of ripeness and then treated accordingly.

1. A system for controlling pests on plants that are located in an agricultural area, having
a swarm of drones which are configured to fly to plants autonomously and are each equipped with a sensor for detecting pest infestation, and
a control device for controlling the drones, wherein the control device and the drones are equipped with communication devices for mutual exchange of data, the drones have a maximum size of 25 cm and are equipped with a laser device suitable for pest control and are configured to effect targeted control of detected pest infestation by means of the laser device.

2. The system according to claim 1, wherein the laser device has an automatically adjustable optical system by means of which the focal point is adjustable.

3. The system according to claim 1, wherein the control device is configured to define an agricultural target area to be treated and to communicate that area to the drones, the drones being configured to fly to plants within the defined target area.

4. The system according to claim 1, wherein the drones are configured to communicate with one another directly or via the control device.

5. The system according to claim 1, wherein the drones are configured to transmit data captured by their sensors to the control device; and the control device is configured to analyse data transmitted by the drones and consequently transmit control information to the drones.

6. The system according to claim 1, wherein the drones have a maximum take-off weight of 500 g.

7. The system according to claim 1, wherein the drones are equipped with a position determination device.

8. The system according to claim 1, wherein the drones have an orientation arrangement for orienting the laser device with respect to a target object.

9. The system according to claim 1, wherein the drones are equipped with an electrical energy storage means; the system has at least one charging device for the energy storage means of the drones; and in the event of their energy storage means requiring charging, the drones are configured to discontinue their activity, autonomously fly to the at least one charging device, charge their energy storage means and resume their activity automatically once their energy storage means has been charged.

10. The system according to claim 9, wherein it has at least one landing platform for the drones ; the landing platform offers space for a plurality of drones; and the at least one charging device is integrated in the landing platform.

11. The system according to claim 10, wherein the landing platform has an electrical charging energy storage means for supplying energy to the at least one charging device.

12. The system according to claim 11, wherein the landing platform has a photovoltaic panel or is itself configured as a photovoltaic panel and the charging energy storage means chargeable by means of the photovoltaic panel.

13. The system according to claim 10, wherein the landing platform is mobile.

14. The system according to claim 13, wherein the landing platform is self-propelling.

15. The system according to claim 1, wherein at least some functionalities of the control device are implemented as software provided on a server in the internet.
